(19) United States
(12) Patent Application Publication
(10) Pub. No.: US 2022/0248213 A1
(43) Pub. Date: Aug. 4, 2022

(54) METHOD AND APPARATUS FOR INFORMATION REPORTING, CONFIGURATION METHOD AND APPARATUS, MULTI-SIM TERMINAL, AND BASE STATION

(71) Applicant: BEIJING XIAOMI MOBILE SOFTWARE CO., LTD., Beijing (CN)

(72) Inventor: Wei HONG, Beijing (CN)

(21) Appl. No.: 17/623,734

(22) PCT Filed: Jul. 1, 2019
(86) PCT No.: PCT/CN2019/094241

§ 371 Date: Dec. 29, 2021

(51) Int. Cl. H04W 8/20; H04W 76/10; H04L 5/22

(52) U.S. Cl. CPC H04W 8/205; H04W 88/06; H04L 5/22; H04W 76/10

(57) ABSTRACT

A method for information reporting. A multi-SIM terminal establishes a RRC connection with a base station, and reports its multi-SIM information to the base station during establishing the RRC connection with the base station. The base station receives the multi-SIM information of the multi-SIM terminal reported by the multi-SIM terminal, and configures the multi-SIM terminal on the basis of the multi-SIM information.

### CROSS-REFERENCE TO RELATED APPLICATION

This application is the US national phase application of International Application No. PCT/CN2019/094241, filed on Jul. 1, 2019, the entire content of which is incorporated herein by reference for all purposes.

### TECHNICAL FIELD

The disclosure relates to the field of communications technologies, and particularly to a method and apparatus for information reporting, a configuration method and apparatus, a multi-SIM terminal, a base station and a computer readable storage medium.

### BACKGROUND

With the development of wireless communication technologies, more and more multi-SIM terminals become available to consumers. The typical application scenarios of multi-SIM terminals are as follows. Scenario 1: A business user has a private card and a business card and places both cards in the same terminal. Scenario 2: A common user has multiple private cards and can choose which SIM card to use based on services. These cards may be from the same carrier, or they may be from different carriers.

### SUMMARY

According to a first aspect of the disclosure, a method for information reporting is provided, which is applied to a multi-SIM terminal, and includes:
establishing a radio resource control (RRC) connection with a base station;
reporting multi-SIM information of the multi-SIM terminal to the base station during establishing the RRC connection with the base station.

According to a second aspect of the present disclosure, a configuration method is provided, which is applied to a base station, and includes:
receiving multi-SIM information of a multi-SIM terminal reported by the multi-SIM terminal;
configuring the multi-SIM terminal according to the multi-SIM information.

According to a third aspect of the present disclosure, a user equipment is provided, including:
a processor; and
a memory configured to store instructions executable by the processor;
wherein, the processor is configured to:
establish a radio resource control (RRC) connection with a base station;
report multi-SIM information of the multi-SIM terminal to the base station during establishing the RRC connection with the base station.

According to a fourth aspect of the present disclosure, a base station is provided, including:
a processor; and
a memory configured to store instructions executable by the processor;
wherein, the processor is configured to:
receive multi-SIM information of a multi-SIM terminal reported by the multi-SIM terminal;
configure the multi-SIM terminal according to the multi-SIM information.

According to a fifth aspect of the present disclosure, there is provided a non-transitory computer readable storage medium stored with computer instructions thereon, which when executed by a processor, causes the processor to implement the method for information reporting described above.

According to a sixth aspect of the present disclosure, there is provided a non-transitory computer readable storage medium stored with computer instructions thereon, which when executed by a processor, causes the processor to implement the configuration method described above.

It should be understood that the general description above and the detailed description below are illustrative and explanatory only and do not limit the disclosure.

### BRIEF DESCRIPTION OF THE DRAWINGS

The appended drawings herein are incorporated into the specification and form part of the specification, showing embodiments consistent with the present invention and used together with the specification to explain the principles of the present invention.

FIG. 1 is a flowchart of a method for information reporting according to an example embodiment of the disclosure.

FIG. 2 is a flowchart of a configuration method according to an example embodiment of the disclosure.

FIG. 3 is a signaling flow chart of a configuration method according to an example embodiment of the disclosure.

FIG. 4 is a block diagram of an apparatus for information reporting according to an example embodiment of the disclosure.

FIG. 5 is a block diagram of a configuration apparatus according to an example embodiment of the disclosure.

FIG. 6 is a block diagram suitable for an apparatus for information reporting according to an example embodiment of the disclosure.

FIG. 7 is a block diagram suitable for a configuration apparatus according to an example embodiment of the disclosure.

### DETAILED DESCRIPTION

Embodiments will be explained in detail here, and examples are shown in the attached drawings. Where the following description relates to appended drawings, the same numbers in different appended drawings indicate the same or similar elements, unless otherwise indicated. Implementations described in the following example embodiments do not represent all implementations consistent with the present invention. Rather, they are merely examples of devices and methods which are consistent with some aspects of the invention as detailed in the attached claims.

Currently, processing methods for multi-SIM terminals are mainly implemented based on various terminal manufacturers, without a unified implementation standard, which leads to many different terminal behaviors and processing methods, and may lead to the following problems:
1) When the terminal reads paging or measures in a second system, it will cause a short interval of about 20 ms in a first system.
2) When the terminal decides to switch to a cell of the second system, it needs to read system information in the second system, which will result in a long interval of about 1 second in the first system.
3) Tracking Area Update (TAU) performed by the terminal in the second system will result in a longer interval of several seconds in the first system.

When afore-mentioned problems appear, due to the fact that the base station does not know the terminal is a multi-SIM terminal, the base station may consider a shorter interval (tens of milliseconds) as a problem of wireless side, but for a longer interval, would considered it as an error condition, which will lead to wrong guidance for control algorithms, and may even cause a radio link failure and trigger a corresponding recovery mechanism. Therefore, autonomous behaviors of multi-SIM terminals may disrupt data statistics and related algorithms. In addition, as the base station does not know that the terminal is a multi-SIM terminal, it may continue to page the terminal after the terminal is disconnected from the first system, resulting in a waste of system resources.

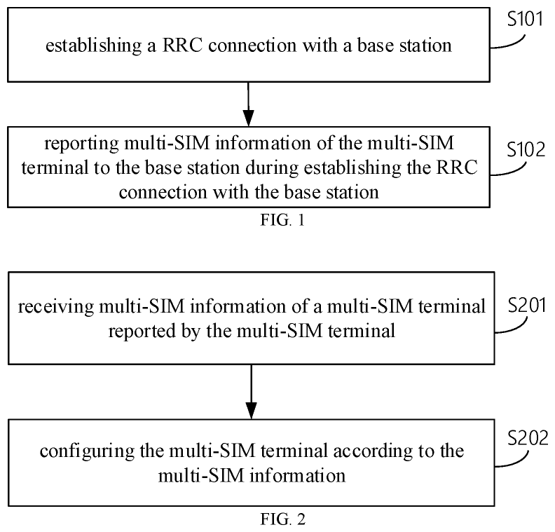

FIG. 1 is a flowchart of a method for information reporting shown in an example embodiment of the present disclosure, which is described from the multi-SIM terminal side. As shown in FIG. 1, the method for information reporting includes followings.

In Step S101, a Radio Resource Control (RRC) connection is established with a base station.

In this embodiment, the multi-SIM terminal may be installed with multi-SIM cards belonging to different network operators.

The multi-SIM terminal can access randomly through one or more Subscriber Identification modules (SIMS) to establish RRC connection with the base station. The base station may include 5th-Generation Communications System (5G) New Radio (NR) base station, and may also include Fourth Generation Communications system (4G) Evolved Node BS (Enb). The network where the 5G NR base station is located and the network where the 4G Enb is located may belong to different network operators.

In step S102, multi-SIM information of the multi-SIM terminal is reported to the base station during establishing the RRC connection with the base station.

The multi-SIM terminal may report multi-SIM information to the base station through a third message (MSG3). The multi-SIM information includes identity information of multi-SIM cards installed in the multi-SIM terminal, such as multiple SIM cards. The identity information may include at least one of S-TMSI (Short for Serving-Temporary Mobile Subscriber Identity), random number (randomValue), a first part of a next generation 5G service temporary mobile subscriber identity (ng-5g-s-TMSI-part1), the next generation 5G service temporary mobile subscriber identity (ng-5g-s-TMSI) and International Mobile Subscriber Identification Number (IMSI).

When the multi-SIM terminal establishes an RRC connection with a 5G NR base station, the multi-SIM terminal may report its multi-SIM information in a Radio Resource Control Setup Request (RRCSetupRequest) signaling. For example, the multi-SIM information may be carried through the following RRCSetupRequest signaling. The multi-SIM information carried is shown in bold. After receiving the multi-SIM information of the multi-SIM terminal, the 5G NR base station can configure the multi-SIM terminal based on the multi-SIM information.

| | |
|---|---|
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| ue-Identity1 | InitialUE-Identity, |
| establishmentCause | EstablishmentCause, |
| spare | BIT STRING (SIZE (1)) |
| } | |

When the multi-SIM terminal establishes an RRC connection with a 4G Enb, the multi-SIM terminal may report its multi-SIM information in a Radio Resource Control connection Request (RRCConnectionRequest) signaling. For example, the multi-SIM information may be carried through the following RRCConnectionRequest. The multi-SIM information carried is shown in bold. After receiving the multi-SIM information of the multi-SIM terminal, the 4G Enb can configure the multi-SIM terminal based on the multi-SIM information.

| | |
|---|---|
| RRCConnectionRequest ::= | SEQUENCE { |
| criticalExtensions | CHOICE { |
| rrcConnectionRequest-r8 | RRCConnectionRequest-r8-IEs, |
| rrcConnectionRequest-r15 | RRCConnectionRequest-5GC-r15-IEs |
| rrcConnectionRequest-r17 | RRCConnectionRequest-r17-IEs |
| } | |
| } | |
| RRCConnectionRequest-r17-IEs ::= | SEQUENCE { |
| ue-IdentityList | UE-IdentityList |
| establishmentCause | EstablishmentCause, |
| spare | BIT STRING (SIZE (1)) |
| } | |

In the above embodiment, the multi-SIM information of the multi-SIM terminal is reported to the base station during establishing the RRC connection with the base station, so that the base station can know the current terminal is the multi-SIM terminal, so as to make targeted configuration for the multi-SIM terminal as early as possible.

FIG. 2 is a flowchart of a configuration method shown in an example embodiment of the present disclosure, which is described from the base station side. As shown in FIG. 2, the configuration method includes followings.

In step S201, multi-SIM information of a multi-SIM terminal reported by the multi-SIM terminal is received.

In this embodiment, a third message (MSG3) sent by the multi-SIM terminal may be received and the multi-SIM information may be obtained from the MSG3.

When the current base station is a 5G NR base station, the MSG3 is RRCSetupRequest signaling. When the current base station is a 4G Enb, the MSG3 is RRCConnectionRequest signaling.

The multi-SIM information includes identity information of multi-SIM cards installed in the multi-SIM terminal, such as the identity information of multiple SIM cards. The identity information may include at least one of S-TMSI (Short for Serving-Temporary Mobile Subscriber Identity), random number (randomValue), a first part of a next generation 5G service temporary mobile subscriber identity (ng-5g-s-TMSI-part1), the next generation 5G service temporary mobile subscriber identity (ng-5g-s-TMSI) and International Mobile Subscriber Identification Number (IMSI).

In Step S202, the multi-SIM terminal is configured based on the multi-SIM information.

After receiving the multi-SIM information of the multi-SIM terminal reported by the multi-SIM terminal, the multi-SIM terminal can be configured according to the multi-SIM information. For example, a time-division multiplexing (TDM) mode may be configured to the multi-SIM terminal according to the multi-SIM information. The TDM mode is used for the multi-SIM terminal to operate on multiple networks belonging to multiple operators in different time periods.

In the above embodiment, by receiving the multi-SIM information of the multi-SIM terminal reported by the multi-SIM terminal, and configuring the multi-SIM terminal according to the multi-SIM information, the base station can know that the current terminal is the multi-SIM terminal, and thus can make a specific configuration for the multi-SIM terminal as early as possible, to make correct guidance for control algorithms and reduce the waste of system resources.

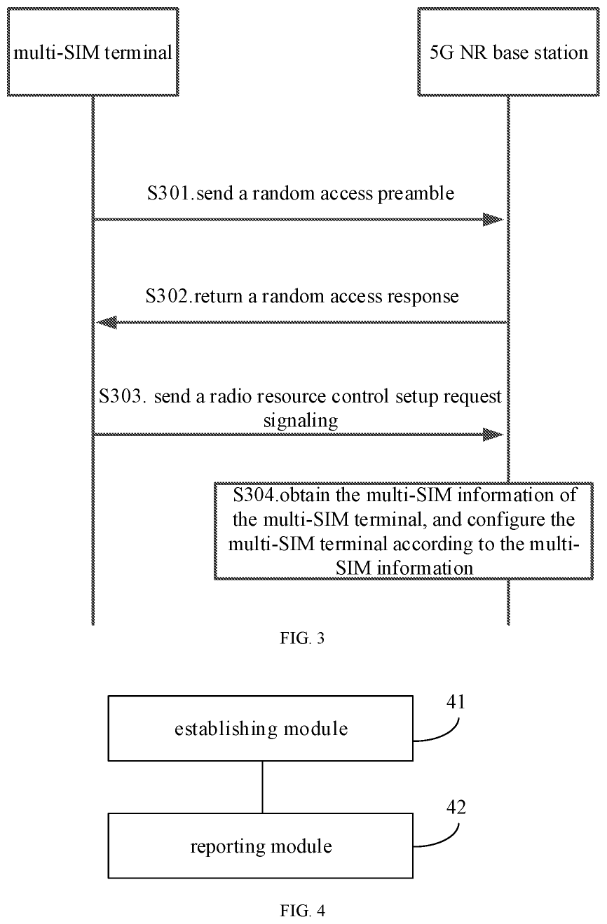

FIG. 3 is a signaling flow chart of a configuration method shown in an example embodiment of the present disclosure, which is described from the perspective of interaction between the multi-SIM terminal and the base station. In this embodiment, the multi-SIM terminal initiates random access to the 5G NR base station through a SIM. As shown in FIG. 3, the configuration method includes followings.

In step S301, the multi-SIM terminal sends a random access preamble to the base station.

In step S302, the base station returns a random access response to the multi-SIM terminal.

In step S303, the multi-SIM terminal sends a radio resource control setup request (RRCSetupRequest) signaling to the base station, in which the RRCSetupRequest signaling carries the multi-SIM information of the multi-SIM terminal.

In step S304, the base station obtains the multi-SIM information of the multi-SIM terminal from the RRCSetupRequest signaling, and carries out relevant configuration for the multi-SIM terminal according to the multi-SIM information.

In the above embodiment, through the interaction between the multi-SIM terminal and the base station, the multi-SIM terminal can report the multi-SIM information of the multi-SIM terminal to the base station in the process of establishing the RRC connection with the base station, so that the base station can know the current terminal is the multi-SIM terminal, so as to make targeted configuration for the multi-SIM terminal as early as possible.

FIG. 4 is a block diagram of an apparatus for information reporting shown in an example embodiment of the present disclosure, which is applied to a multi-SIM terminal. As shown in FIG. 4, the apparatus for information reporting includes an establishing module 41 and a reporting module 42.

The establishing module 41 is configured to establish a Radio Resource Control (RRC) connection with a base station.

The multi-SIM terminal can access randomly through one or more Subscriber Identification modules (SIMS) to establish RRC connection with the base station. The base station may include 5th-Generation Communications System (5G) New Radio (NR) base station, and may also include Fourth Generation Communications system (4G) Evolved Node BS (Enb).

The reporting module 42 is configured to report multi-SIM information of the multi-SIM terminal to the base station during the establishing module 41 establishes the RRC connection with the base station.

The multi-SIM terminal may report multi-SIM information to the base station through a third message (MSG3). The multi-SIM information includes identity information of multi-SIM cards installed in the multi-SIM terminal, such as multiple SIM cards. The identity information may include at least one of S-TMSI (Short for Serving-Temporary Mobile Subscriber Identity), random number (randomValue), a first part of a next generation 5G service temporary mobile subscriber identity (ng-5g-s-TMSI-part1), the next generation 5G service temporary mobile subscriber identity (ng-5g-s-TMSI) and International Mobile Subscriber Identification Number (IMSI).

When the multi-SIM terminal establishes an RRC connection with a 5G NR base station, the multi-SIM terminal may report its multi-SIM information in a Radio Resource Control Setup Request (RRCSetupRequest) signaling. For example, the multi-SIM information may be carried through the following RRCSetupRequest signaling. The multi-SIM information carried is shown in bold. After receiving the multi-SIM information of the multi-SIM terminal, the 5G NR base station can configure the multi-SIM terminal based on the multi-SIM information.

| | |
|---|---|
| RRCSetupRequest ::= | SEQUENCE { |
| rrcSetupRequest | RRCSetupRequest-IEs |
| } | |
| RRCSetupRequest-IEs ::= | SEQUENCE { |
| ue-Identity | InitialUE-Identity, |
| ue-Identity1 | InitialUE-Identity, |
| establishmentCause | EstablishmentCause, |
| spare | BIT STRING (SIZE (1)) |
| } | |

When the multi-SIM terminal establishes an RRC connection with a 4G Enb, the multi-SIM terminal may report its multi-SIM information in a Radio Resource Control connection Request (RRCConnectionRequest) signaling. For example, the multi-SIM information may be carried through the following RRCConnectionRequest. The multi-SIM information carried is shown in bold. After receiving the multi-SIM information of the multi-SIM terminal, the 4G Enb can configure the multi-SIM terminal based on the multi-SIM information.

| | |
|---|---|
| RRCConnectionRequest ::= | SEQUENCE { |
| criticalExtensions | CHOICE { |
| rrcConnectionRequest-r8 | RRCConnectionRequest-r8-IEs, |
| rrcConnectionRequest-r15 | RRCConnectionRequest-5GC-r15-IEs |
| rrcConnectionRequest-r17 | RRCConnectionRequest-r17-IEs |
| } | |
| } | |
| RRCConnectionRequest-r17-IEs ::= | SEQUENCE { |
| ue-IdentityList | UE-IdentityList |
| establishmentCause | EstablishmentCause, |
| spare | BIT STRING (SIZE (1)) |
| } | |

In the above embodiment, the multi-SIM information of the multi-SIM terminal is reported to the base station during establishing the RRC connection with the base station, so that the base station can know the current terminal is the multi-SIM terminal, so as to make targeted configuration for the multi-SIM terminal as early as possible.

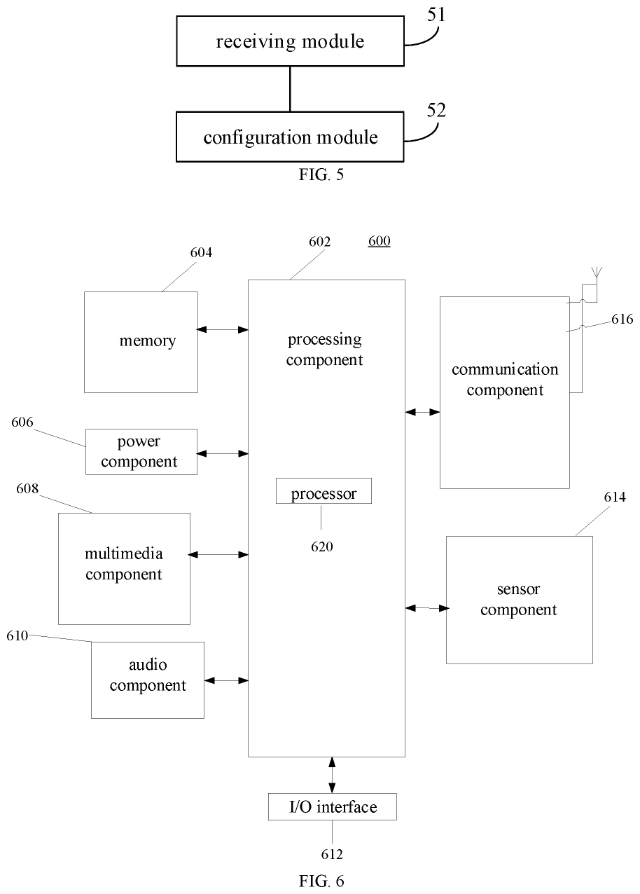

FIG. 5 is a block diagram of a configuration apparatus shown in an example embodiment of the present disclosure, which is applied to a base station. As shown in FIG. 5, the configuration apparatus includes a receiving module 51 and a configuration module 52.

The receiving module 51 is configured to receive multi-SIM information of a multi-SIM terminal reported by the multi-SIM terminal.

In this embodiment, a third message (MSG3) sent by the multi-SIM terminal may be received and the multi-SIM information may be obtained from the MSG3.

When the current base station is a 5G NR base station, the MSG3 is RRCSetupRequest signaling. When the current base station is a 4G Enb, the MSG3 is RRCConnectionRequest signaling.

The multi-SIM information includes identity information of multi-SIM cards installed in the multi-SIM terminal, such as the identity information of multiple SIM cards. The identity information may include at least one of S-TMSI (Short for Serving-Temporary Mobile Subscriber Identity), random number (randomValue), a first part of a next generation 5G service temporary mobile subscriber identity (ng-5g-s-TMSI-part1), the next generation 5G service temporary mobile subscriber identity (ng-5g-s-TMSI) and International Mobile Subscriber Identification Number (IMSI).

The configuration module 52 is configured to configure the multi-SIM terminal based on the multi-SIM information.

After receiving the multi-SIM information of the multi-SIM terminal reported by the multi-SIM terminal, the multi-SIM terminal can be configured according to the multi-SIM information. For example, a time-division multiplexing (TDM) mode may be configured to the multi-SIM terminal according to the multi-SIM information. The TDM mode is used for the multi-SIM terminal to operate on multiple networks belonging to multiple operators in different time periods.

In the above embodiment, by receiving the multi-SIM information of the multi-SIM terminal reported by the multi-SIM terminal, and configuring the multi-SIM terminal according to the multi-SIM information, the base station can know that the current terminal is the multi-SIM terminal, and thus can make a specific configuration for the multi-SIM terminal as early as possible, to make correct guidance for control algorithms and reduce the waste of system resources.

FIG. 6 is a block diagram suitable for an apparatus for information reporting according to an example embodiment of the disclosure. For example, the apparatus 600 may be a mobile phone, a computer, a digital broadcasting terminal, a messaging device, a game console, a tablet device, a medical equipment, a fitness equipment, a personal digital assistant, etc.

As illustrated in FIG. 6, the apparatus 600 may include one or more components: a processing component 602, a memory 604, a power component 606, a multimedia component 608, an audio component 610, an input/output (I/O) interface 612, a sensor component 614, and a communication component 616.

The processing component 602 typically controls overall operations of the apparatus 600, such as the operations associated with display, telephone calls, data communications, camera operations, and recording operations. The processing component 602 may include one or more processors 620 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

One processor 620 in the processing component 602 may be configured to:
establish a radio resource control (RRC) connection with a base station;
report multi-SIM information of the multi-SIM terminal to the base station during establishing the RRC connection with the base station.

The memory 604 is configured to store various types of data to support the operation of the apparatus 600. Examples of such data include instructions for any applications or methods operated on the apparatus 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the apparatus 600. The power component 606 may include a power management system, one or more power sources, and any other components associated with the generation, management, and distribution of power in the apparatus 600.

The multimedia component 608 includes a screen providing an output interface between the apparatus 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the apparatus 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the apparatus 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the apparatus 600. For instance, the sensor component 614 may detect an open/closed status of the apparatus 600, relative positioning of components, e.g., the display and the keypad, of the apparatus 600, a change in position of the apparatus 600 or a component of the apparatus 600, a presence or absence of user contact with the apparatus 600, an orientation or an acceleration/deceleration of the apparatus 600, and a change in temperature of the apparatus 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the apparatus 600 and other devices. The apparatus 600 can access a wireless network based on a communication standard, such as WiFi, 2G, or 3G, or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an example embodiment, the apparatus 600 may be implemented by one or more application specific integrated circuits(ASIC), digital signal processors (DSP), digital signal processing devices (DSPD), programmable logic devices (PLD), field programmable gate arrays (FPGA), controllers, microcontrollers, microprocessors or other electronics components, to perform the method as described in the above any embodiment.

In an example embodiment, there is also provided a non-transitory computer-readable storage medium including instructions, such as included in the memory 604, executable by the processor 620 in the apparatus 600, for performing the above-described methods. For example, the non-transitory computer-readable storage medium may be a ROM, a RAM, a CD-ROM, a magnetic tape, a floppy disc, an optical data storage device, and the like.

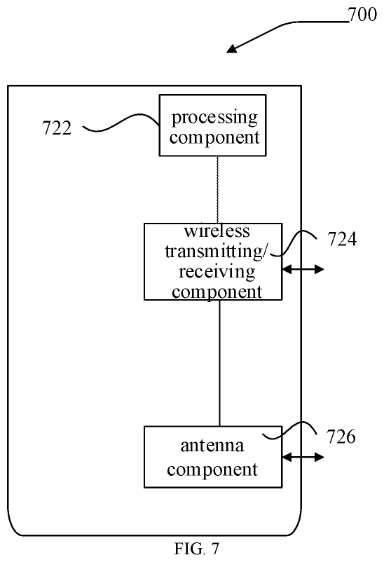

FIG. 7 is a block diagram suitable for a configuration apparatus according to an example embodiment of the present disclosure. The apparatus 700 may be provided as a base station. Referring to FIG. 7, the apparatus 700 includes a processing component 722, a wireless transmitting/receiving component 724, an antenna component 726, and a signal processing portion specific to the wireless interface. The processing component 722 may further include one or more processors.

One processor in the processing component 722 may be configured to:
receive multi-SIM information of a multi-SIM terminal reported by the multi-SIM terminal;
configure the multi-SIM terminal based on the multi-SIM information.

In an example embodiment, there is also provided a non-transitory computer-readable storage medium including instructions, executable by the processing component 722 in the apparatus 700, for performing the above-described methods. For example, the non-transitory computer-readable storage medium may be a ROM, a RAM, a CD-ROM, a magnetic tape, a floppy disc, an optical data storage device, and the like.

For apparatus embodiments, as they basically correspond to method embodiments, please refer to part of method embodiments for relevant information. The apparatus embodiments described above are only illustrative, where the units described as separate parts may or may not be physically separate, and the parts shown as units may or may not be physical units, that is, may be located in one place, or may be distributed over multiple network units. Part or all of the modules can be selected according to the actual needs to achieve the purpose of this disclosure. Ordinary technical personnel in this field can understand and implement without creative labor.

It should be noted that, in this context, relational terms such as first and second are used only to distinguish one entity or operation from another, and do not necessarily require or imply any such actual relationship or order between these entities or operations. The term “including”, “include” or any of its other variants is intended to cover a non-exclusive contain, which includes a series of elements of the process, method, item or equipment not only includes those elements, but also no clear list of other elements, or also includes objects for the process, method, or device inherent elements. Without further restriction, an element defined by the statement “including a . . . ” does not exclude the existence of other identical elements in the process, method, article or equipment that includes the element.

After considering the specification and practicing the disclosure herein, those skilled in the art will easily think of other embodiments of the present disclosure. The present application is intended to cover any variations, usages, or adaptive changes of the present disclosure. These variations, usages, or adaptive changes follow the general principles of the present disclosure and include common knowledge or conventional technical means in the technical field not disclosed by the present disclosure.

It should be understood that the present disclosure is not limited to the precise structure described above and shown in the drawings, and various modifications and changes may be made without departing from its scope.

1. A method for information reporting, applied to a multi-SIM terminal, comprising:
establishing a radio resource control (RRC) connection with a base station; and
reporting multi-SIM information of the multi-SIM terminal to the base station during establishing the RRC connection with the base station.

2. The method of claim 1, wherein reporting multi-SIM information of the multi-SIM terminal to the base station during establishing the RRC connection with the base station comprises:
reporting the multi-SIM information to the base station through a third message MSG3, wherein the multi-SIM information comprises identity information of multi-SIM cards installed in the multi-SIM terminal, and the identity information comprises at least one of a serving-temporary mobile subscriber identity (S-TMSI), a random number (randomValue), a first part of a next generation 5G service temporary mobile subscriber identity (ng-5G-S-TMSI-Part1), the next generation 5G service temporary mobile subscriber identity (ng-5G-S-TMSI) and an international mobile subscriber identification number (IMSI).

3. The method of claim 2, wherein the MSG3 comprises a radio resource control setup request (RRCSetupRequest) signaling or a radio resource control connection request (RRCConnectionRequest) signaling.

4. A configuration method, applied to a base station, comprising:
receiving multi-SIM information of a multi-SIM terminal reported by the multi-SIM terminal;
configuring the multi-SIM terminal according to the multi-SIM information.

5. The method of claim 4, wherein receiving multi-SIM information of a multi-SIM terminal reported by the multi-SIM terminal comprises:
receiving a third message MSG3 sent by the multi-SIM terminal, and obtaining the multi-SIM information from the MSG3.

6. The method of claim 5, wherein the MSG3 comprises a radio resource control setup request (RRCSetupRequest) signaling or a radio resource control connection request (RRCConnectionRequest) signaling.

7. The method of claim 4, wherein configuring the multi-SIM terminal according to the multi-SIM information comprises:
configuring a time-division multiplexing (TDM) mode for the multi-SIM terminal according to the multi-SIM information, wherein the TDM mode is used for the multi-SIM terminal to operate on multiple networks belonging to multiple operators in different time periods.

8. The method of claim 4, wherein the multi-SIM information comprises identity information of multi-SIM cards installed in the multi-SIM terminal, and the identity information comprises at least one of a serving-temporary mobile subscriber identity (S-TMSI), a random number (randomValue), a first part of a next generation 5G service temporary mobile subscriber identity (ng-5G-S-TMSI-Part1), the next generation 5G service temporary mobile subscriber identity (ng-5G-S-TMSI) and an international mobile subscriber identification number (IMSI).

9-16. (canceled)

17. A user equipment, comprising:
a processor; and
a memory configured to store instructions executable by the processor;
wherein, the processor is configured to:
establish a radio resource control (RRC) connection with a base station;
report multi-SIM information of the multi-SIM terminal to the base station during establishing the RRC connection with the base station.

18. A base station, comprising:
a processor; and
a memory configured to store instructions executable by the processor;
wherein, the processor is configured to implement the configuration method according to claim 4.

19-20. (canceled).

21. The user equipment of claim 17, wherein the processor is configured to:
report the multi-SIM information to the base station through a third message MSG3, wherein the multi-SIM information comprises identity information of multi-SIM cards installed in the multi-SIM terminal, and the identity information comprises at least one of a serving-temporary mobile subscriber identity (S-TMSI), a random number (randomValue), a first part of a next generation 5G service temporary mobile subscriber identity (ng-5G-S-TMSI-Part1), the next generation 5G service temporary mobile subscriber identity (ng-5G-S-TMSI) and an international mobile subscriber identification number (IMSI).

22. The user equipment of claim 21, wherein the MSG3 comprises a radio resource control setup request (RRCSetupRequest) signaling or a radio resource control connection request (RRCConnectionRequest) signaling.
